(19) United States
(12) Patent Application Publication
(10) Pub. No.: US 2017/0266922 A1
(43) Pub. Date: Sep. 21, 2017

(54) SURFACE-FINISHED STEEL SHEET AND METHOD FOR THE PRODUCTION THEREOF

(71) Applicants: ThyssenKrupp Steel Europe AG, Duisburg (DE); ThyssenKrupp AG, Essen (DE)

(72) Inventors: Patrick Kuhn, Kamen (DE); Martin Norden, Essen (DE); Axel Schrooten, Dortmund (DE)

(73) Assignees: ThyssenKrupp Steel Europe AG, Duisburg (DE); ThyssenKrupp AG, Essen (DE)

(21) Appl. No.: 15/505,163

(22) PCT Filed: Aug. 19, 2015
(86) PCT No.: PCT/EP2015/069017

§ 371 Date: Feb. 20, 2017

(30) Foreign Application Priority Data
Aug. 20, 2014 (EP) 14181621.5

(51) Int. Cl. B32B 15/01; B32B 15/18; C23C 2/06; C23C 2/40; C25D 7/06; C21D 8/02; C21D 9/46; C22C 21/02; C25D 3/12; C25D 5/48; B32B 15/04; C23F 17/00

(52) U.S. Cl. CPC B32B 15/015; B32B 15/043; B32B 15/18; C23C 2/06; C23C 2/40; C23F 17/00; C21D 8/0273; C21D 8/0278; C21D 9/46; C22C 21/02; C25D 3/12; C25D 5/48; C25D 7/0614

(57) ABSTRACT

A surface-finished steel sheet, in some examples cold-rolled thin steel sheet, includes a metallic corrosion-resistant layer that may comprise more than 40% by weight aluminum and iron. So that that corrosion-resistant layer has high formability, especially cold formability, and hence significantly improved adhesion on forming, the corrosion-resistant layer may comprises nickel, wherein nickel-containing phases are located at a transition from the corrosion-resistant layer to a base material of the steel sheet. The nickel content of the corrosion resistant layer may be in a range from 5 to 30% by weight. Further, a method for producing a surface-finished steel sheet of this kind is also disclosed. In some examples, a nickel layer may be applied to a steel sheet, preferably cold-rolled thin steel sheet in the form of flat steel product, prior to hot-dip coating the steel sheet with a liquid aluminum melt or with a liquid melt of aluminum-based alloy.

The invention relates to a surface-finished steel sheet, preferably cold-rolled thin steel sheet, having a metallic corrosion-resistant layer whose constituents include aluminum and iron, the aluminum content of the corrosion-resistant layer being more than 40 wt %, preferably more than 45 wt %, more preferably more than 50 wt %. The invention further relates to a method for producing a steel sheet surface-finished with a metallic corrosion-resistant layer, which comprises hot-dip coating a flat steel product, preferably cold-rolled thin steel sheet, with aluminum or an aluminum-based alloy.

Because of poor corrosion resistance, uncoated carbon steels, including, in particular, boron-alloyed tempering steels, are provided with metallic corrosion resistance. In the prior art this is typically accomplished by hot-dip coating with zinc or aluminum based metal melts. Hot-dip galvanized thin steel sheet combines the outstanding corrosion resistance of the zinc with the strength of steel. Hot-dip aluminized thin steel sheet combines outstanding corrosion resistance with thermal robustness. A further advantage is the combination of the visual appearance of aluminum with the strength of steel. Known in particular is thin steel sheet provided by hot-dip coating with an aluminum-silicon covering.

Hot dip-finished thin steel sheet is used in particular in automobile construction, where three-dimensionally shaped bodywork and chassis components are produced by forming from individual cut-to-size sheets of the thin sheet metal.

In order to reduce the vehicle weight and fuel consumption, there is increasing use of tempering steels which are distinguished by ready formability in the heated state and, after hot forming with rapid cooling (press hardening), by particularly high strength. Where one known tempering steel is that of grade 22MnB5. The outstanding strength qualities of this grade of steel are achieved, besides the carbon and the manganese, in particular by a small fraction of boron.

A disadvantage of known aluminum-silicon coverings of the kind widely employed in hot forming, however, is their only limited suitability for cold forming. These coverings are therefore unsuitable if, for example, there is a call for cold forming ahead of a hot forming application. The reason is that it has emerged that the cold forming of steel sheet having these coverings is accompanied by delamination of the coating in the forming-stressed regions of the component, with a loss of corrosion resistance at the delamination sites.

On this basis, it is an object of the invention to create a steel sheet of the type specified at the outset with a corrosion-resistant layer that permits easy formability, especially cold formability, and has a significantly improved adhesion on forming. A steel sheet of this kind is preferably also to be suitable for hot forming (press hardening).

This object is achieved by a surface-finished steel sheet having the features indicated in claim 1, and also by a method for producing a surface-finished steel sheet with the features indicated in claim 9. Preferred and advantageous embodiments of the steel sheet of the invention and of the method for producing it are indicated in the dependent claims.

The steel sheet of the invention is provided with a metallic corrosion-resistant layer which comprises aluminum, nickel, and iron, the aluminum content of the corrosion-resistant layer being more than 40 wt %, preferably more than 45 wt %, more preferably more than 50 wt %, while the nickel content of the corrosion-resistant layer is in the range from 5 to 30 wt %, preferably in the range from 10 to 25 wt %, with nickel-containing phases being formed in particular at the transition from the corrosion-resistant layer to the base material of the steel sheet.

The method of the invention is characterized accordingly in that the flat steel product in question, preferably cold-rolled thin steel sheet, before being hot-dip coated, is first of all provided with a nickel layer.

In-house experiments by the applicant have shown that the corrosion-resistant layer of the invention exhibits significantly increased ductility and adhesion on cold forming relative to the known aluminum and aluminum-silicon hot-dip coverings. The experiments have shown in particular that steel sheet made of boron-alloyed tempering steel is also suitable, with a corrosion-resistant layer of the invention, for hot forming (press hardening).

The nickel layer is applied preferably by means of an electrolytic coating operation.

The coating operation, preferably electrolytic coating operation for preliminary coating of the flat steel product or cold-rolled thin steel sheet with nickel, is performed, according to one advantageous embodiment of the method of the invention, in such a way that the nickel layer applied as a result of the operation has a layer thickness in the range from 1 to 5 μm, preferably in the range from 3 to 5 μm. By this means it is possible to further increase and/or optimize the ductility and adhesion of the corrosion-resistant layer of the invention.

According to a further embodiment of the method of the invention, the nickel layer can be applied reliably and economically to the flat steel product or cold-rolled thin steel sheet by using a nickel electrolyte for the electrolytic coating operation that is based on nickel sulfate and nickel chloride.

A further advantageous embodiment of the method of the invention is characterized in that before being hot-dip coated, the flat steel product provided with the nickel layer is subjected to a recrystallizing annealing treatment under inert gas. This enhances the formability, particularly the cold formability, of the flat steel product. The recrystallizing annealing treatment comprises holding at a defined temperature for a defined duration, and controlled cooling after attainment of the desired properties. The annealed flat steel product provided with the nickel layer is preferably cooled to a temperature which lies above the temperature of the melt bath and is not more than 20° C. different from said temperature. The annealed flat steel product is cooled at a defined rate, so that the properties obtained are not adversely affected. Annealing in inert gas prevents the flat steel product provided with the nickel layer from being oxidized prior to hot-dip coating, or other unwanted surface reactions occurring.

The subsequent hot-dip coating is carried out preferably in such a way that the resulting corrosion-resistant layer comprising aluminum, iron, and nickel has a layer thickness in the range from 8 to 20 μm, preferably in the range from 10 to 15 μm, more preferably in the range from 10 to 12 μm. By this means it is possible economically to achieve very reliable corrosion resistance with optimum adhesion of the corrosion-resistant layer on cold forming of the coated flat steel product.

Used for hot-dip coating in the method of the invention is a melt bath which preferably comprises a pure aluminum melt apart from unavoidable impurities. Alternatively, however, in the method of the invention it is also possible to use a melt bath which comprises an aluminum melt with up to 10 wt % of silicon. Experiments by the applicant have shown, nevertheless, that the corrosion-resistant layer of the invention exhibits optimum adhesion on cold forming when a substantially pure aluminum melt is used.

If the hot-dip coating which follows the electrolytic coating operation for applying a nickel layer is carried out using a silicon-containing aluminum melt, the method parameters are preferably set such that the metallic corrosion-resistant layer of the correspondingly surface-finished steel sheet has an Si content of less than 8 wt %, preferably less than 5 wt %.

The preliminary coating in the form of the electrolytically applied nickel layer suppresses the diffusion of iron from the steel sheet (flat steel product) into the aluminum applied by hot-dip coating. The method parameters are preferably set such that in the outer layer half of the metallic corrosion-resistant layer of the correspondingly surface-finished steel sheet, the nickel content is greater than the iron content.

Furthermore, the method parameters are preferably set in such a way that intermetallic AlNi phases are produced or formed in the corrosion-resistant layer of the invention.

Base material used for producing the steel sheet of the invention is preferably a press-hardenable steel, e.g. steel of grade 22MnB5.

The invention is elucidated in more detail below by exemplary embodiments, with reference to the appended figures, of which:

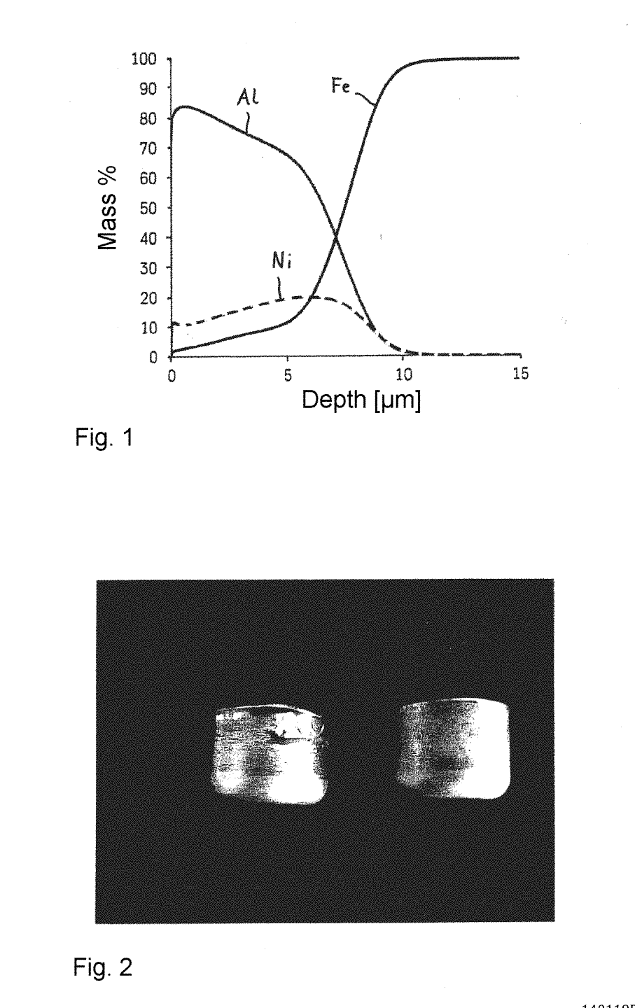

FIG. 1 shows an element depth profile, determined by glow discharge spectroscopy (GDOES), of a steel sheet coated in accordance with the invention; and

FIG. 2 shows cold-drawn cups, the left-hand cup having been produced from a steel sheet bearing a conventional AlSi covering, and the right-hand cup from a steel sheet bearing an Al—Ni covering of the invention.

To produce a steel sheet surface-finished with a metallic corrosion-resistant layer, cold-rolled thin sheet strip having a metal-sheet thickness of approximately 1.25 mm was provided, in a continuous electrolytic coating operation, with a nickel layer around 3 μm thick or, in one variant, with a nickel layer around 1 μm thick. For this purpose, in each case, a Watts nickel electrolyte was used, based on nickel sulfate and nickel chloride. This coating operation may also be referred to as an electroplating operation. Cold-rolled thin sheet strip used in each case was a steel strip (base material) of grade 22MnB5.

The electrolytically nickel thin-coated sheet strip was next passed on for annealing treatment in a continuous hot-dip coating unit. In the continuous oven upstream of the coating bath in the hot-dip coating unit, the nickel-precoated fine sheet strip was given a recrystallizing anneal under an atmosphere of inert gas or forming gas (about 95% nitrogen, 5% hydrogen, dew point −30° C.). After a hold time of 60 seconds at a temperature of around 800° C., the annealed fine sheet strip was cooled to a bath dip temperature of around 705° C. and then guided through the coating bath. In one preferred variant, the coating bath consisted substantially of pure liquid aluminum melt. In another variant, the coating bath used consisted of an aluminum melt containing about 10 wt % of silicon. The layer thickness of the aluminum covering or AlSi covering applied in this way was adjusted, by means of scraping nozzles disposed above the coating bath, such that the layer thickness of the metallic corrosion-resistant layer formed from the nickel layer and the hot-dip covering was approximately 10 μm. This metallic corrosion-resistant layer may also be referred to as an aluminum-nickel alloy layer.

FIG. 1 shows the composition of a corrosion-resistant layer of the invention, obtained after the hot-dip coating operation, on a steel sheet having undergone preliminary nickel-coating, on the basis of an element depth profile. The dashed line shows the nickel content in wt % relative to the depth of the metallic corrosion-resistant layer. The line beginning at the bottom left and rising almost to 100 wt % indicates the Fe content of the corrosion-resistant layer relative to its depth, while the third line relates to the Al content.

It is apparent that in this example, the nickel content close to the surface of the corrosion-resistant layer is in the range from 10 to 12 wt %. In the direction of the cold-rolled thin sheet, the nickel content of the approximately 10 μm thick corrosion-resistant layer increases to about 19 to 20 wt % at a depth of up to about 6 μm. Thereafter the nickel content of the corrosion-resistant layer gradually drops in the direction of the coated thin sheet.

The aluminum content of the corrosion-resistant layer exhibits its maximum close to the surface of the layer. In the case of this example, the maximum Al content is situated in the range from about 82 to 86 wt %. The nickel coating (preliminary nickel coating) has suppressed the iron content of the aluminum, giving the covering a much lower brittleness or much greater ductility than the known AlSi covering. In FIG. 1 it can be seen that the nickel content in the outer layer half of the corrosion-resistant layer is much greater than the iron content.

For evaluating the formability of the corrosion-resistant layer of the invention, cold-rolled thin steel sheets of grade 22MnB5, coated accordingly, were subjected to cold forming, specifically by deep-drawing to form circular cups, and the adhesion of their coverings was compared, on the basis of the appearance of the corrosion-resistant layer, with that of a known Al—Si hot-dip covering (as reference) and also of a known Al hot-dip covering (see table). Furthermore, sample production was varied by producing different nickel layer thicknesses and by investigating samples without preliminary nickel coating as well.

The table shows that by means of a sufficiently thick nickel layer, it is possible to increase significantly the ductility and adhesion of the covering (corrosion-resistant layer) on cold forming relative to that of known AlSi and Al hot-dip coverings (samples 1 and 4). The photographs in FIG. 2 provide further illustration of this.

The left-hand cup in FIG. 2 was produced by cold deep-drawing of a thin steel sheet bearing a conventional AlSi covering. The right-hand cup, in contrast, was produced by cold deep-drawing of a thin steel sheet having an Al—Ni covering of the invention. Whereas the left-hand cup exhibits significant delamination of the AlSi covering in the forming-stressed region of the cup, no instances of delamination can be ascertained on the right-hand cup.

The corrosion-resistant layer of the invention is therefore distinguished by significantly increased ductility and at the same time by significantly enhanced adhesion in cold forming. In addition, the corrosion-resistant layer of the invention further possesses the property of scale protection afforded by the known AlSi covering for hot forming. The corrosion-resistant layer of the invention is therefore likewise suitable for hot forming. The advantages of the present invention can be utilized also in particular when producing components by roll profiling and subsequent hardening.

TABLE
Comparison of covering adhesion/cold formability

| | | | | In accordance |
|---|---|---|---|---|
| Sample | Designation | | Adhesion of | with |
| No. | of covering | Production | covering | invention |
| 1 | AlSi | Al melt with 10 wt % Si | Poor, severe | no |
| | (Reference) | | delaminations | |
| 2 | AlNi | 3 μm preliminary Ni | Very good, no | yes |
| | | coating hot-dip coated | delaminated | |
| | | with pure aluminum | areas | |
| 3 | AlNi | 1 μm preliminary Ni | Good, but slight | yes |
| | | coating hot-dip coated | delaminations | |
| | | with pure aluminum | apparent | |
| 4 | AlFe | Without preliminary Ni | Poor, severe | no |
| | | coating hot-dip coated | delaminations | |
| | | with pure aluminum | apparent | |
| 5 | AlSiNi | 3 μm preliminary Ni | Good, but slight | yes |
| | | coating hot-dip coated | delaminations | |
| | | with AlSi | apparent | |

1.-16. (canceled)

17. A surface-finished steel sheet comprising a metallic corrosion-resistant layer that comprises:
more than 40% by weight aluminum;
iron; and
5 to 30% by weight nickel, wherein nickel-containing phases are located at a transition from the metallic corrosion-resistant layer to a base material of the surface-finished steel sheet.

18. The surface-finished steel sheet of claim 17 wherein the metallic corrosion-resistant layer further comprises silicon.

19. The surface-finished steel sheet of claim 18 wherein the metallic corrosion-resistant layer comprises less than 8% by weight silicon.

20. The surface-finished steel sheet of claim 18 wherein the metallic corrosion-resistant layer comprises less than 5% by weight silicon.

21. The surface-finished steel sheet of claim 17 wherein an outer half layer of the metallic corrosion-resistant layer contains more nickel than iron.

22. The surface-finished steel sheet of claim 17 wherein the base material is cold-rolled thin steel sheet.

23. The surface-finished steel sheet of claim 17 wherein the base material is press-hardenable steel.

24. The surface-finished steel sheet of claim 17 wherein the metallic corrosion-resistant layer comprises intermetallic AlNi phases.

25. The surface-finished steel sheet of claim 17 wherein the metallic corrosion-resistant layer has a thickness in a range from 8 to 20 μm.

26. The surface-finished steel sheet of claim 17 wherein the metallic corrosion-resistant layer has a thickness in a range from 10 to 15 μm.

27. The surface-finished steel sheet of claim 17 wherein the metallic corrosion-resistant layer comprises more than 50% by weight aluminum.

28. The surface-finished steel sheet of claim 17 wherein the metallic corrosion-resistant layer comprises 10 to 25% by weight nickel.

29. A method for producing a steel sheet surface-finished with a metallic corrosion-resistant layer, the method comprising:
applying a nickel layer to a flat steel product; and
hot-dip coating the flat steel product with aluminum or an aluminum-based alloy after the nickel layer is applied to the flat steel product.

30. The method of claim 29 wherein the nickel layer applied to the flat steel product has a thickness in a range from 1 to 5 μm.

31. The method of claim 29 wherein the nickel layer is applied to the flat steel product by way of an electrolytic coating operation.

32. The method of claim 31 wherein a nickel electrolyte used for the electrolytic coating operation is based on nickel sulfate and nickel chloride.

33. The method of claim 29 further comprising subjecting the flat steel product with the nickel layer to a recrystallizing annealing treatment under inert gas before hot-dip coating the flat steel product.

34. The method of claim 29 wherein the hot-dip coating is carried out such that a resultant corrosion-resistant layer comprises aluminum, iron, and nickel and has a layer thickness in a range from 8 to 20 μm.

35. The method of claim 29 wherein a melt bath used for the hot-dip coating comprises a pure aluminum melt and unavoidable impurities.

36. The method of claim 29 wherein a melt bath used for the hot-dip coating comprises an aluminum melt with up to 10% by weight silicon.
